(19) United States
(12) Patent Application Publication
(10) Pub. No.: US 2022/0003626 A1
(43) Pub. Date: Jan. 6, 2022

(54) LEAK DETECTION SYSTEM AND METHOD OF USE THEREOF

(71) Applicants: William Smith, Moggill (AU); Ying Li, Moggill (AU); Duncan Hywel-Evans, Mundoolun (AU)

(72) Inventors: William Smith, Moggill (AU); Ying Li, Moggill (AU); Duncan Hywel-Evans, Mundoolun (AU)

(21) Appl. No.: 16/995,955

(22) Filed: Aug. 18, 2020

(30) Foreign Application Priority Data
Jul. 3, 2020 (AU) 2020902287

(51) Int. Cl. G01M 3/00

(52) U.S. Cl. CPC G01M 3/00

(57) ABSTRACT

A leak detection system and method of use thereof is disclosed based on shock wave propagation in a fluid. In one form, the system includes at least one shock wave generator for introducing at least one shock wave signal into a fluid medium; at least one detector for detecting signals in the fluid medium; and at least one processor configured to identify excitation signals in the fluid medium caused by the at least one shock wave signal, wherein the identification of excitation signals is indicative of a fluid leak.

### CROSS-REFERENCE TO RELATED APPLICATION

This application claims the benefit of Australian Provisional Patent Application No. 2020902287, filed Jul. 3, 2020, which is incorporated by reference herein in its entirety.

### TECHNICAL FIELD

The present invention relates to a leak detection system and method of use thereof.

### BACKGROUND

Urban utility networks supply water to most urban consumers, including private houses and industrial, commercial or institution establishments. Typically, such networks comprise a network of buried and underground pipes and pipelines.

Over time, these pipes and pipelines can develop leaks resulting in a loss of potable water. Indeed, it is estimated that approximately 2.1 trillion gallons of potable water is lost in the US each year due to aging and leaky pipes, broken water mains and faulty metres.

Generally, leak detection and location in pipes, particularly in underground or buried water supply mains, is a difficult and expensive exercise. Consequently, many leaks go unattended.

Traditional methods of leak detection in underground or buried pipes include tracking water losses with flow measurements and consumption and/or the use of above ground microphones. Such methods apart from being costly and labour intensive, are also generally imprecise in identifying the particular location of a leak.

The inventor has previously addressed one or more of the abovementioned problems by virtue of his leak detection and location system as disclosed in International Patent Application No. PCT/AU2019/050855. However, the prior system failed to achieve its practical objectives, and, the inventor has subsequently invented a new system providing enhanced performance and functionality over the prior system.

It will be clearly understood that, if a prior art publication is referred to herein, this reference does not constitute an admission that the publication forms part of the common general knowledge in the art in Australia or in any other country.

### SUMMARY OF INVENTION

Embodiments of the present invention provide a leak detection system and method of use thereof, which may at least partially address one or more of the problems or deficiencies mentioned above or which may provide the public with a useful or commercial choice.

According to a first aspect of the present invention, there is provided a fluid leak detection system for detecting a fluid leak at a fluid-solid boundary, said system including:

at least one shock wave generator for introducing at least one shock wave signal into a fluid medium;

at least one detector for detecting signals in the fluid medium; and

at least one processor configured to identify excitation signals in the fluid medium caused by said at least one shock wave signal, wherein identification of said excitation signals is indicative of the fluid leak.

According to a second aspect of the present invention, there is provided a shock wave generator for a fluid leak detection system, said generator including:

an excitation source; and

a resonator operatively associated with the excitation source and a fluid medium, said resonator configured to be excited by the excitation source and introduce at least one shock wave signal into the fluid medium.

Advantageously, embodiments of the present invention provide a fluid leak detection system that is able to readily identify and locate fluid leaks without the cost or labour associated with conventional methods. By using at least one shock wave signal, the signal advantageously is able propagate further along a fluid medium than previous systems thereby enabling greater versatility. Further, the at least one shock wave signal creates a characteristic excitation signal at any fluid leak site identified that is readily detectable and a great improvement over the sound wave distortion taught in earlier systems. In turn, this greatly improves the accuracy of the system over previous systems.

As indicated above, the system of the present invention is for fluid leak detection at a fluid-solid boundary. The present invention is at least in part predicated on the principle that the introduction of the at least one shock wave signal into a fluid medium causes detectable excitation signals at fluid-solid boundaries, such as, e.g., a leak site, which can be used to identify and locate a site of a leak.

More specifically, the introduction of the at least one shock wave may cause a momentary step change in pressure from accumulated and compressed sound waves. The introduction of the at least one shock wave into the fluid medium may causes cavitation or “bubble-pulses” on features of the fluid-solid boundary.

Cavitation or bubble-pulses is a phenomenon in which a rapid change in pressure in a fluid medium results in the formation of at least one vapour-filled cavity or bubble. The bubble-pulse may be caused by the initial shock wave causing a rapid change of pressure and imparting an energy of motion into the fluid medium resulting in the formation of the vapor-filled bubble.

Upon formation, the bubble may expand radially outward beyond a point at which its internal pressure equals a hydrostatic head of the surrounding fluid medium. Hydrostatic pressure of the surrounding fluid medium may then halt radial expansion of the bubble and, since an interior of the bubble is at a lower pressure, the bubble may begin to contact. At a point of collapse, at least one secondary shock wave may be emitted, and the cycle of expansion and contraction may be repeated until all the energy of motion is dissipated.

Each cycle of expansion and contraction may be referred to as a “pulse”. Generally, each succeeding pulse may decrease in amplitude and duration.

The pulses may have a characteristic frequency profile that may be detected with the at least one detector. The frequency profile may be characterised in having a series of peaks with decreasing amplitude and duration as a function of time. The series of peaks may correspond to the over pressure profile of the bubble pulse and typically may have substantially greater amplitude than other signals corresponding to background noise.

The system of the present invention is primarily intended for use in detecting and preferably locating a leak in a conduit containing a fluid and hereinafter will be described with reference to this example application. However, a person skilled in the art will appreciate that the system is capable of broader applications, such as, e.g., stealthy sonar, dam leaks, and ship hull leaks.

The system may be permanently installed along a length of conduit for fixed condition monitoring of the length of conduit or may be provided as a portable test instrument. For example, the system may be installed at one point to monitor a length of conduit.

The length of conduit monitored may be of any suitable length. For example, the length of conduit may have a length of about 50 m, about 100 m, about 150 m, about 200 m, about 250 m, about 300 m, about 350 m, about 400 m, about 450 m, about 500 m, about 550 m, about 600 m, about 650 m, about 700 m, about 750 m, about 800, about 850 m, about 900 m, about 950 m, about 1,000 m, about 1,050 m, about 1,100 m, about 1,150 m, about 1,200 m, about 1,250 m, about 1,300 m, about 1,350 m, about 1,400 m, about 1,450 m, about 1,500 m, about 1,550 m, about 1,600 m, about 1,650 m, about 1,700 m, about 1,750 m, about 1,800 m, about 1,850 m, about 1,900 m, about 1,950 m, about 2,000 m, about 2,050 m, about 2,100 m, about 2,150 m, about 2,200 m, about 2,250 m, about 2,300 m, about 2,350 m, about 2,400 m, about 2,450 m, or about 2,500 m or more. Typically, the length of conduit monitored may have a length up to about 2,250 m, preferably about 2,000 m.

The conduit may include any tubular section used to convey a flowable fluid medium, preferably a liquid fluid medium, such as, e.g., water, refined petroleum, fuels, oil, biofuel, chemical solutions, oil and other fluids.

Generally, the conduit may be an underground or buried conduit. The conduit may typically include a pair of opposed ends and at least one sidewall extending longitudinally therebetween. Usually, the at least one sidewall is curved such that the conduit has a circular profile shape, although non-circular conduits are also encompassed. The conduit may typically be joined end-to-end with other like conduits to span distances.

The conduit may typically be formed from any suitable material or materials capable of conveying the fluid medium. Generally, the conduit may be formed from ceramic, concrete fibreglass, plastic and/or metal material or materials, typically steel, copper, aluminium, concrete or plastic material or materials, preferably steel or high-density polyethylene (HDPE).

The conduit may include one or more access points or connections for accessing internal contents of the conduit. The access points may include a fitting, such as, e.g., a saddle or tee fitting. The connections may include a branch conduit, for example. The one or more access points or connections preferably enable the internal contents of the conduit to be accessed without interrupting a flow of the fluid medium in the conduit or requiring emptying of the conduit.

The at least one shock wave generator may be of any suitable size, shape and construction for introducing at least one shock wave signal into the fluid medium, preferably by producing a supersonic pulse. The at least one shock wave generator may introduce the at least one shock wave signal via the one or more access points or connections in the conduit. The supersonic pulse may become a shock wave at the fluid medium interface and may further cause a bubble pulse. The resultant shock wave and bubble pulse noise may travel at sonic speeds in the fluid medium.

In some embodiments, the at least one shock wave generator may include a laser capable of ionizing water molecules. In such embodiments, the breaking down of water molecules may generate a shock wave signal.

In other similar embodiments, the at least one shock wave generator may include a cutting laser capable of ablating material in a pipe to cause an explosion and a resulting shock wave signal. The material ablated may preferably be metal material or materials.

In further embodiments, the at least one shock wave generator may include an air gun. The air gun may include one or more pneumatic chambers pressurised with compressed air. When fired into the fluid medium, a solenoid may be triggered to release air into a fire chamber, which in turn may cause a piston to move thereby allowing the air to escape the main chamber and produce a supersonic pulse to generate the at least one shock wave signal.

In other embodiments, the at least one shock wave generator may include a striker and a diaphragm configured to be struck by the striker. The diaphragm may have one side in contact with the fluid medium and an opposed side configured to be struck by the striker to generate a supersonic pulse that is propagated in the fluid medium as the at least one shock wave signal.

The diaphragm may be of any suitable size, shape and construction and may be formed from any suitable material or materials capable of producing a supersonic pulse, such as, e.g., plastic and/or metal material or materials, preferably plastic, more preferably high-density polyethylene (HDPE).

In preferred such embodiments, the diaphragm may further include at least one resonator section. The resonator section may be of any suitable size, shape and construction to resonate and emit a supersonic pulse when struck by the striker. The resonator section may be integrally formed with a remainder of the diaphragm or may be of separate construction. Likewise, the resonator section may be formed from the same material or a different material to a remainder of the diaphragm, such as, e.g., HDPE, aluminium or titanium, preferably aluminium or titanium due to their ability to transmit sound at faster speeds than less dense material or materials.

The resonator section may be machined into a central portion of the diaphragm, and may preferably span longitudinally between both sides of the diaphragm.

Typically, the diaphragm may be of any suitable thickness. The diaphragm may be of uniform or varying thicknesses. In some embodiments, the thickness of the diaphragm may be dictated by a length of the resonator section. In some embodiments, the diaphragm may have a thickness between the opposed sides of between about 1 mm and about 5 mm.

Any suitable striker may be used for striking the diaphragm and causing the diaphragm to produce the supersonic pulse. The striker may be of any suitable size, shape and construction and may be formed from any suitable material or materials, preferably a material harder than the diaphragm and/or the resonator section.

In some embodiments, the striker may be in the form of a weight configured to fall under the force of gravity or under the force of a biasing member or mechanism, such as, e.g., one or more springs, and strike the diaphragm, preferably the resonator section.

Typically, the striker may form part of a striking mechanism including an actuating mechanism for moving the striker between a striking position in which it strikes the diaphragm and a retracted position. Any suitable type of actuating mechanism may be used.

The actuating mechanism may be manually actuated or by using a drive, preferably the latter. Movement may be linear or rotary.

In some embodiments, the actuating mechanism may include one or more biasing mechanisms. In some such embodiments, movement of the striker to the striking position may work against the force of the biasing mechanism, so that striker moves to the retracted position under the force of the biasing mechanism. In other such embodiments, movement of the striker to the striking position may work under the force of the biasing mechanism and movement of the striker to the retracted position may work against the force of the biasing mechanism.

The biasing mechanism may include one or more springs, such as, e.g., coil or leaf springs. Of course, a person skilled in the art will appreciate that other types of biasing mechanisms, such as, e.g., magnets or magnetized elements and the like may be used.

In some such embodiments, the actuating mechanism for driving the striker into the striking position may be an electromechanical solenoid.

In other such embodiments, the actuating mechanism for driving the striker into the striking position may be a magneto strictive arrangement.

In yet other such embodiments, the actuating mechanism for driving the striker into the striking position may be an electro strictive arrangement.

In other embodiments, the at least one shock wave generator may include a resonator capable of producing a supersonic pulse that causes at least one shock wave signal in the fluid medium.

The resonator may be of any suitable size, shape and construction and formed from any suitable material capable of resonating and emitting a supersonic pulse when at least partially compressed, preferably struck. The resonator may be formed from plastic or metal material or materials, preferably metal, more preferably aluminium.

The resonator may include a pair of opposed ends and an elongate body extending therebetween, preferably linearly. The resonator may be of tubular or solid construction, preferably the latter. The pair of opposed ends may be open, closed or a combination thereof.

In such embodiments, the shock wave generator may further include a body for at least partially housing the resonator and an excitation source for exciting the resonator. The excitation source may include any source suitably capable of causing the resonator to at least resonate.

The body may include an upper wall, an opposed lower wall and at least one side wall extending therebetween.

The lower wall may be configured to be connectable to the conduit, conduit branch or an access point such that resonator is at least in fluid communication with the fluid medium in the conduit.

The at least one side wall may be curved or rounded. The at least one side wall may also be connectable to the conduit, conduit branch or an access point. In some embodiments, the at least one side wall may further include a connecting mechanism or part of a connecting mechanism for connecting to the conduit, conduit branch or an access point, such as, e.g., a threaded outer surface configured to threadingly engage with a threaded surface of the conduit, conduit branch or access point.

The body may preferably be of solid construction. The body may include a bore extending through the body, preferably entirely between and through the upper and lower walls. The bore may be sized and shaped to at least partially receive the resonator.

The resonator may be received in the bore such that an upper end of the resonator at least partially protrudes above the upper wall of the body and a lower end of the resonator may at least partially protrude past the lower wall of the body, and preferably be in contact with or near the fluid medium.

In some such embodiments, the resonator may be slidably received in the bore. For example, the resonator may be slidable between a raised position in which the upper end of the resonator at least partially protrudes outwards from the upper wall of the body and a lowered position.

In preferred embodiments, the excitation source may include a striking mechanism for striking the upper end of the resonator and thereby exciting the resonator to generate a supersonic pulse. The striking mechanism may be as previously described.

The striker of the striking mechanism may include a hammer, plunger or piston for striking the upper end of the resonator. The striker may be formed of plastic or metal material or materials, preferably a material harder than the resonator, more preferably brass.

In some embodiments, the lower end of the resonator may include an inwardly curved or concave surface.

In other embodiments, the lower end of the resonator may include at least one concave recess defined thereon. The at least one concave recess may include curved or angled sidewalls, preferably the latter.

When struck by the striking mechanism, the resonator may act as a piston in the bore and the lower end of the resonator may displace at least a portion of the fluid medium. In such embodiments, the inwardly curved or concave surface or concave recess defined on the lower end of the resonator may at least partially assist in guiding and/or shaping the at least one shock wave signal propagated in the fluid medium away from the shock wave generator.

Advantageously, the inwardly curved or concave surface or concave recess defined on the lower end of the resonator may also at least partially shape a resulting void that is formed. For example, a flat resonator lower end may result in a substantially dish-shaped void whereas the inwardly curved or concave surface or concave recess defined on the lower end of the resonator may increase the thickness of the void.

The at least one shock wave signal introduced into the fluid medium by the shock wave generator may be in the form of a shock wave which may travel through the fluid medium along the conduit.

Alternatively, the at least one shock wave signal introduced into the fluid medium may create at least one bubble-pulse at the lower end of the resonator, which may generate secondary shock waves that travel along the conduit in the fluid medium as the bubble-pulse pulses. The secondary shock waves may create further bubble-pulses along the conduit, such as, e.g., at a fluid leak site.

As indicated, the system includes at least one detector for detecting signals in the fluid medium, preferably excitation signals caused by propagation of at least one shock wave signal in the fluid medium. The excitation signals may preferably include signals corresponding to a bubble-pulse.

The at least one detector may be of any suitable size, shape and construction, and may be located in any suitable location relative to the at least one shock wave generator.

Generally, the at least one detector may include any suitable detector capable of identifying a frequency profile characteristic or indicative of a bubble-pulse.

In preferred embodiments, the at least one detector may include at least one hydrophone. In some such embodiments, the at least one hydrophone may be a directional hydrophone.

The at least one detector may be located together with, or away from, the at least one shock wave generator, preferably the latter.

For example, in some embodiments, the at least one shock wave generator and the at least one detector may or may not form a single unit and may be located on one side of a leak site in a conduit.

In other embodiments, the at least one shock wave generator and the at least one detector may be separately located relative to the conduit and the leak site in the conduit.

For example, in one such embodiment, the at least one shock wave generator and the at least one detector may be located on opposite sides of the leak site.

In another such embodiment, the at least one shock wave generator and the at least one detector may be located on a same side of a leak site but separated from one another.

A person skilled in the art will appreciate that an operator will normally not know a location of a leak site and therefore in ordinary operation may arrange the at least one shock wave generator and the at least one detector apart from one another in a spaced arrangement to define a test length of conduit. The operator may then move the test length along a length of the conduit while maintaining the spaced arrangement until a leak site is detected and located.

Usually, like with the at least one shock wave generator, the at least one detector may be located in the conduit via the one or more access points or connections as previously described, preferably in line with the fluid medium in the conduit.

In some embodiments, the system may include more than one detector. For example, the system may include two, three, four or five or more detectors. The detectors may be located in any suitable arrangement relative to the at least one shock wave generator and the conduit. For example, the detectors may be arranged on either side of the at least one shock wave generator along a length of conduit.

As indicated, the system includes at least one processor configured to identify excitation signals in the fluid medium caused by said at least one shock wave signal to thereby identify a leak site. Further, the at least one processor may be configured to measure a time between introduction of the at least one shock wave signal and detection of the excitation signals to determine a location of the leak site. For example, the at least one shock wave signal may travel through the fluid medium at a speed of 1,500 m·s⁻¹. Accordingly, if an excitation signal is detected 1 second after introduction of the at least one shock wave signal, it may be determined to be about 750 m away.

The at least one processor may typically form part of a processing device including one or more processors and memory. The one or more processors may include multiple inputs and outputs coupled to electronic components of the system.

For example, the processors may have at least one input coupled to the at least one input coupled to the at least one detector. Likewise, the processors may have an output coupled to the at least one shock wave generator, typically at least one output and at least one input.

The processing device may include a microcomputer, an external processing device, such as, e.g., a computer, a tablet, a smart phone, a PDA or at least one remotely accessible server. In other embodiments, the processing device may include a dedicated microprocessor operatively associated with one or both of the at least one shock wave generator and the at least one detector.

The processing device may be operatively associated with the at least one shock wave generator and the at least one detector for at least collecting data corresponding to the timing of the initiation of the at least one shock wave signal and resulting signals detected in the fluid medium, including the amplitude, duration and timing of said resulting signals.

The system may further include a communications module for connecting the system to an external device, such as, e.g., an external processing device, a controller, an external display or a storage device. The system may be connected to the external device in any suitable way.

For example, in some such embodiments, the communications module may be in the form of a port or access point (e.g., a USB or mini-USB port) such that the system may be connected to the external device using a suitable cable.

In other such embodiments, the communications module may be in the form of a wireless communications module, such as, e.g., a wireless network interface controller, such that the system may wirelessly connect to the external device via a wireless network, e.g., a Wi-Fi (WLAN) communication, Satellite communication, RF communication, infrared communication, or Bluetooth™). In such embodiments, the communications module may include at least one modem, such as, e.g., a cellular or radio modem.

In some embodiments, the system may include a power supply for powering electrical components of the system, including the at least one shock wave generator and the at least one detector. The power source may include an on-board power source, such as, e.g., one or more batteries. In other embodiments, the power source may include an external power source, such as, e.g., a mains supply or generator.

In some embodiments, the system may further include a controller for controlling operation of the at least one shock wave generator and the at least one detector. The controller may be operatively connected to the at least one shock wave generator and the at least one detector. The controller may be wired or wirelessly connected to the system.

The controller may preferably be a remote controller. The remote controller may be of any suitable size, shape and form.

The remote controller may include one or more keys, buttons and/or switches for an operator to control operation of the system.

In some embodiments, the remote controller may include at least one display for displaying data transmitted from the system, such as, e.g., signals detected by the at least one detector, preferably as frequency as a function of time.

In some embodiments, the remote controller may be an external computing device, such as, e.g., a laptop or desktop. In such embodiments, the device may further include software configured to be run on the computing device for controlling operation of the system, or at least aspects of the system. The software may preferably be interactive and allow an operator to interact and control operation of the system.

In other embodiments, the remote controller may be a mobile computing device, such as, e.g., a smart phone, a tablet or a smart watch. In such embodiments, the remote controller or device may further include software in the form of an application (i.e., an app) configured to be run on the mobile computing device and allow an operator to interact with and control the system, or at least aspects of the system.

Generally, the excitation signals may be caused by the shock wave signal introduced by the at least one shock wave generator and/or secondary shock waves generated by bubble-pulses travelling through the fluid medium and causing any anomaly on the conduit wall, such as, e.g., a fluid leak, to resonate or create a bubble pulse at the site of the anomaly. Typically, any fluid leak may resonate with a same or similar frequency profile as a bubble-pulse.

Advantageously, the excitation of the leak site may cause the leak site to resonate louder than background noise thereby assisting in the identification of its corresponding excitation signal from the background noise. The identification is further assisted due to its characteristic frequency profile (characterised by a series of peaks with decreasing amplitude and duration as a function of time).

In some embodiments, the at least one processor may be configured to enhance signal strength by removing background noise data. For example, the at least one processor may remove background noise data based on noise signals detected prior to the introduction of the at least one shock wave signal.

In such embodiments, the at least one processor may typically store data indicative of noise signals in the fluid conduit prior to the introduction of the at least one shock wave signal. The data indicative of noise signals may form a database of noise signals.

According to a fourth aspect of the present invention, there is provided a method of detecting a fluid leak, said method including:

introducing at least one shock wave signal into a fluid medium;

sensing one or more parameters of the fluid medium subject to the shock wave signal; and

identifying one or more excitation signals caused by the shock wave signal in the one or more parameters sensed to identify the fluid leak.

The method may include one or more characteristics or features of the system, the shock wave generator and/or the bubble-pulse generator as hereinbefore described.

The introducing may generally include using a shock wave generator to create a supersonic pulse and introduce the at least one shock wave signal into the fluid medium, preferably via the one or more access points or connections for accessing internal contents of the conduit.

The sensing may preferably be undertaken by the at least one detector, preferably at least one hydrophone. The one or more parameters measured may be signals corresponding to sound waves and pressure waves in the fluid medium.

The identifying may generally be undertaken by a processing device, including one or more processors and a memory, such as, e.g., a computing device.

The processing device may identify the one or more excitation signals by analysing the signal data collected by the at least one detector and identifying any signals having a characteristic frequency profile of a bubble-pulse, preferably characterised by a series of peaks of amplitude and duration as a function of time, typically corresponding to the pulses or oscillations of the bubble pulse.

In some embodiments, the processing device may further enhance signal to noise ratio by removing background noise signals. In such embodiments, the processing device may collect and remove background noise data corresponding to background noise signals detected by the at least one detector prior to introduction of the at least one shock wave signal. The processing device may form a refined dataset containing the enhanced signal data that may then be analysed to identify the one or more excitation signals.

In some embodiments, the processing device may filter out noise data to form a filtered dataset that may then be analysed by the processing device to identify the one or more excitation signals. For example, signal data above and below a selectable threshold may be filtered out.

Any of the features described herein can be combined in any combination with any one or more of the other features described herein within the scope of the invention.

The reference to any prior art in this specification is not, and should not be taken as an acknowledgement or any form of suggestion that the prior art forms part of the common general knowledge.

### BRIEF DESCRIPTION OF DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of Invention in any way. The Detailed Description will make reference to a number of drawings as follows:

FIG. 1 is an illustration of a fluid leak detection system according to an embodiment of the present invention;

FIGS. 2A and 2B are illustrations respectively showing a shock wave generator according to an embodiment of the present invention in an inactive and active position;

FIG. 3 is illustration of an upper perspective view of a resonator of the shock wave generator as shown in FIGS. 2A and 2B;

FIG. 4 is an illustration of another shock wave generator according to an embodiment of the present invention;

FIG. 5 is part of a plot showing a characteristic frequency profile of a leak site identified in a conduit and excited by the fluid leak detection system as shown in FIG. 1; and

FIG. 6 is a flowchart showing steps in a method of identifying a fluid leak according to an embodiment of the present invention.

### DETAILED DESCRIPTION

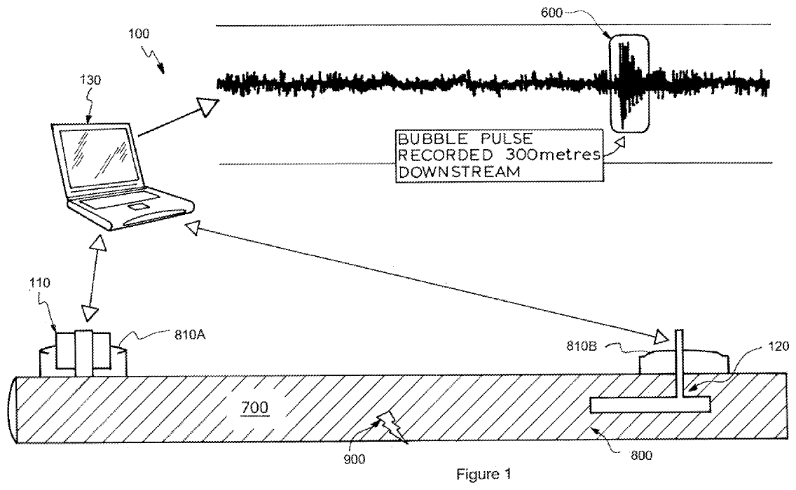

FIGS. 1 to 4 show embodiments of a fluid detection system (100) and parts thereof for detecting a fluid leak (900; shown in FIG. 1 only) in a conduit (800; shown in FIG. 1 only) conveying a liquid fluid medium (700; shown in FIG. 1 only).

Referring to FIG. 1, the fluid detection system (100) includes a shock wave generator (110) for introducing at least one shock wave signal into the fluid medium (700); a detector (120) for detecting signals in the fluid medium (700) and a processing device (130) including one or more processors and a memory for: (i) identifying excitation signals (600) in the fluid medium (700) caused by the shock wave signal to identify a fluid leak (900) in the conduit (800); and (ii) measuring a time between the introduction of the at least one shock wave signal and detection of the excitation signals (600) to determine a location of the leak site (900) in the conduit (800).

Generally, the system (100) works on the principle that the introduction of the at least one shock wave signal into the fluid medium (700) causes a detectable excitation signal (600) in the form of a bubble-pulse at the site of the fluid leak (900).

The bubble-pulse is a phenomenon in which a rapid change in pressure in the fluid medium (700) results in the formation of at least one vapour-filled cavity or bubble. The bubble-pulse is caused by the initial shock wave causing a rapid change of pressure and imparting an energy of motion into the fluid medium (700) resulting in the formation of the vapor-filled bubble.

Upon formation, the bubble expands radially outward beyond a point at which its internal pressure equals a hydrostatic head of the surrounding fluid medium (700). Hydrostatic pressure of the surrounding fluid medium (700) then halts radial expansion of the bubble and, since an interior of the bubble is at a lower pressure, the bubble contacts. At a point of collapse, at least one secondary shock wave is emitted, and the cycle of expansion and contraction is repeated until all the energy of motion is dissipated.

Each cycle of expansion and contraction may be referred to as a “pulse”. Generally, each succeeding pulse may decrease in amplitude and duration.

The pulses or excitation signals (600) have a characteristic frequency profile that can be detected with the detector (120). The frequency profile is characterised by a series of peaks with decreasing amplitude and duration as a function of time. The series of peaks correspond to the over pressure profile of the bubble pulse and have substantially greater amplitude than other signals corresponding to background noise in the fluid medium (700).

As shown, the conduit (800) is a tubular section for conveying the flowable fluid medium (700), which in this embodiment is water.

The conduit (800) is an underground conduit and includes a pair of opposed ends and at least one sidewall extending longitudinally therebetween. The conduit (800) is joined end-to-end with other like conduits to span distances.

The conduit (800) is formed from high-density polyethylene (HDPE).

As shown, the conduit (800) includes two access points (810) for accessing internal contents of the conduit (800).

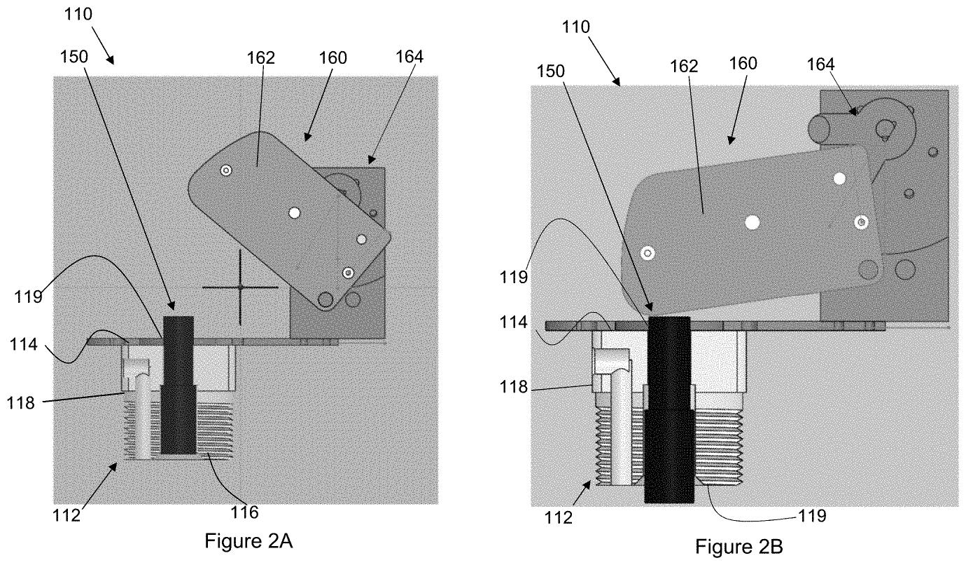

The shock wave generator (110) is capable of introducing at least one shock wave signal into the fluid medium (700) by producing a supersonic pulse. The shock wave generator (110) introduces the at least one shock wave signal via one of the access points (810A) into the conduit. The shock wave generator (110) will be described in greater detail later with reference to FIGS. 2A, 2B, 3 and 4.

The detector (120) is for detecting signals in the fluid medium (700) and is located on an opposite side of the fluid leak (900) relative to the shock wave generator (110). As shown, the detector (120) is located in the conduit (800) via the other access point (810B) in line with the fluid medium (700) in the conduit (800).

The detector (120) is a hydrophone capable of detecting a frequency profile characteristic of a bubble-pulse.

As shown, the processing device (130) is in the form of a laptop computer operatively connected to both the shock wave generator (110) and the detector (120).

The processing device (130) includes software configured to be run on the processing device (130) for controlling operation of the system (100). The software is interactive and allows an operator to interact and control operation of the system (100).

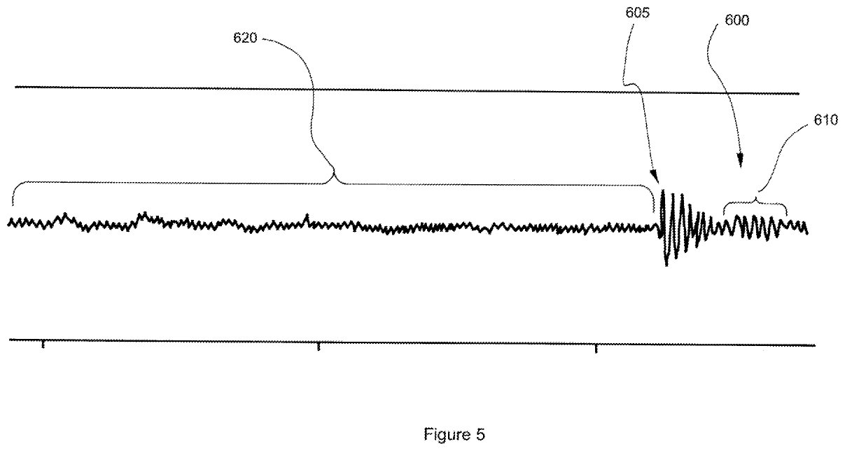

Referring briefly to FIG. 5, in identifying the excitation signals (600) caused by the shock wave signal, the processing device (130; not shown) analyses the signal data collected by the detector (120; not shown) for a frequency profile (610) characteristic of a bubble-pulse frequency profile (605). Signal data identified as having a frequency profile (610) characteristic of a bubble-pulse is identified as an excitation signal (600) and the site of a fluid leak (900; not shown).

Generally, the excitation signals (600) are caused by the shock wave signal introduced by the shock wave generator (110; not shown) and secondary shock waves generated by oscillating bubble-pulses travelling through the fluid medium (700; not shown) and causing any anomaly on the conduit wall, such as, e.g., a fluid leak (900; not shown), to resonate or create a bubble pulse at the site of the anomaly. The fluid leak (900; not shown) resonates with a same or similar frequency profile as a bubble-pulse.

Advantageously, the excitation of the leak site causes the leak site to resonate louder than background noise (620) thereby assisting in the identification of its corresponding excitation signal (600) and characteristic frequency profile (610) from the background noise (620).

Referring back to FIG. 1, the processing device (130) determines a location of the fluid leak (900) by measuring a time between the introduction of the shock wave signal and detection of the excitation signal (600). Accordingly, in a scenario in which a fluid leak (900) is approximately equidistant apart from both the shock wave generator (110) and the detector (120) and bearing in mind that the shock wave travels through the fluid medium (700) at a speed of 1,500 m·s⁻¹, a time of 0.4 seconds between the introduction of a shock wave signal and detection of the excitation signal (600) is indicative of the fluid leak (900) being 300 m away.

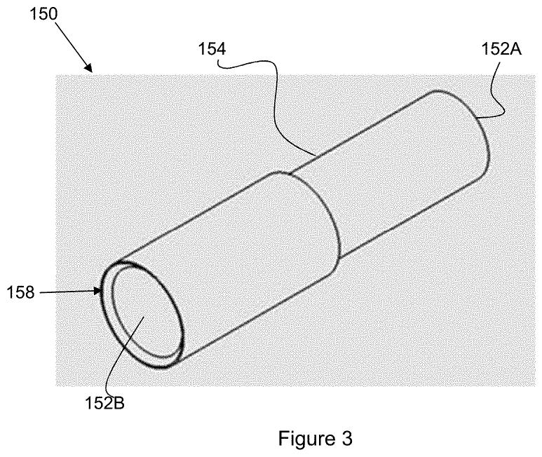

FIGS. 2A, 2B and 3 show embodiments of a shock wave generator (110) and parts thereof for use with the system (100).

Referring to FIGS. 2A and 2B, the shock wave generator (110) includes a resonator (150), a body (112) for at least partially housing the resonator (150) and a striking mechanism (160) for striking the resonator (150) and causing the resonator (150) to produce a supersonic pulse for producing the shock wave signal in the fluid medium (not shown).

Referring briefly to FIG. 3, the resonator (150) is formed from an aluminium rod and includes a pair of opposed ends (152) and an elongate body (154) extending therebetween. The resonator (150) is of a solid construction and has a closed upper end (152A) and a closed lower end (152B).

Referring back to FIGS. 2A and 2B, the body (112) for at least partially housing the resonator (150) includes an upper wall (114), an opposed lower wall (116) and at least one sidewall (128) extending therebetween.

The body (112) is of solid construction and includes a central bore (119) extending entirely between and through the upper and lower walls (114, 116) for slidably receiving the resonator (150).

The lower wall (114) and a portion of the at least one sidewall (118) are connectable to the access point (810) such that a lower end of the resonator (150) is in contact with the fluid medium (700; not shown) in the conduit (800; not shown) when the resonator (150) is in the bore (129).

The upper end of the resonator (150) at least partially protrudes above the upper wall (114) of body (112) for striking by the striking mechanism (160).

The striking mechanism (160) includes a hammer (162; i.e., striker) moveable between a retracted position, shown in FIG. 2A, and a striking position, shown in FIG. 2B, a mechanical actuating mechanism (164) driven by an electric motor for movement of the hammer (162), and a biasing mechanism in the form of one or more coil springs (not shown).

In use, movement of the hammer (162) to the striking position works under the force of the biasing mechanism and movement of the hammer (162) to the retracted position works against the force of the biasing mechanism.

Referring again to FIG. 3, the lower end (152B) of the resonator (150) includes a concave surface (158). When struck by the striking mechanism (160; not shown), the resonator (150) acts partly like a piston in the body (112) and the concave surface (158) of the lower end (152B) displaces at least a portion of the fluid medium (700; not shown) to at least partially assist in guiding the shock wave signal away from the shock wave generator (110) and along the conduit (800; not shown).

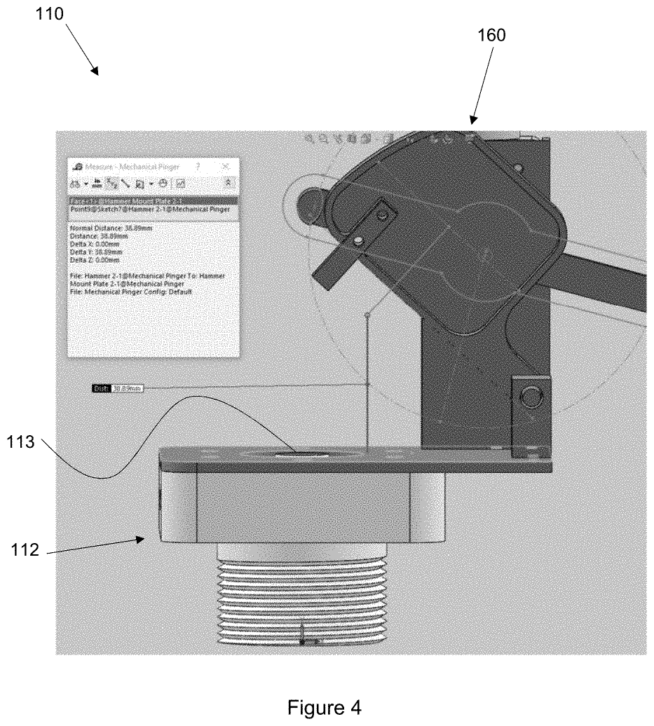

FIG. 4 shows another embodiment of the shock wave generator (110). For convenience, features that are similar or correspond to features of the previous embodiment will be referenced with the same reference numeral.

Referring to FIG. 4, in this embodiment the shock wave generator (110) includes a striking mechanism (160) and a body (112) connectable to an access point (810; not shown) of the conduit (800; not shown) and having a diaphragm (113) including a lower surface in contact with the fluid medium (700; not shown) and an opposed upper surface. The opposed upper surface is configured to be struck by the striking mechanism (160) to generate a supersonic pulse that is propagated into the fluid medium (700; not shown) as the shock wave signal travelling a sonic speed.

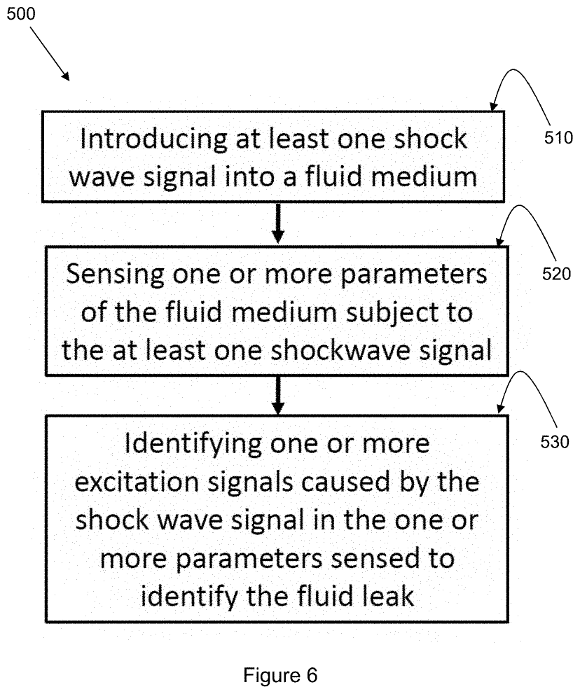

A method (500) of using the system (100) as shown in FIG. 1 to identify and locate a fluid leak (900) in the conduit (800) is now described in detail with reference to FIG. 6.

At step 510, a shock wave signal is introduced into the fluid medium (700) using the shock wave generator (110) via access point (810A) in the conduit (800) containing the fluid medium (700).

At step 520, the detector (120), in the form of the hydrophone located in the fluid medium (700) via access point (810B) of the conduit (800), is used to sense or detect signals in the fluid medium (700).

At step 530, data indicative of the timing of the introduction of the shock wave signal and any signals detected by the detector (120) are transmitted to the processing device (130).

The processing device (130) identifies excitations signals (600) indicative of the fluid leak by analysing the signal data collected for a frequency profile characteristic of a bubble-pulse. Signal data identified as having a frequency profile characteristic of a bubble-pulse is identified as an excitation signal (600) and thus the fluid leak (900).

The processing device (130) further determines a location of the fluid leak (900) in the conduit (800) based on the known positions of the shock wave generator (110) and detector (120) and the known speed of the shock wave signal in the fluid medium, i.e., 1,500 m·s⁻¹. The location is determined based on these known inputs and the time measured between the introduction of the shock wave signal and detection of the excitation signal (600).

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. A fluid leak detecting system for detecting a fluid leak in a conduit containing a liquid fluid medium, said system comprising:
at least one shock wave generator for introducing at least one shock wave signal into the liquid fluid medium;
at least one detector for detecting signals in the liquid fluid medium; and
at least one processor configured to identify excitation signals in the liquid fluid medium caused by said at least one shock wave signal, wherein identification of said excitation signals is indicative of the fluid leak.

2. The system of claim 1, wherein the at least one shock wave generator generates a supersonic pulse that becomes the at least one shock wave signal at an interface of the liquid fluid medium and travels at sonic velocity in liquid fluid medium.

3. The system of claim 2, wherein the at least one shock wave generator is selected from the group consisting of a cutting laser, an air gun, a striker and a diaphragm configured to be struck by the striker, and a resonator.

4. The system of claim 2, wherein the at least one shock wave generator comprises a striker and a diaphragm configured to be struck by the striker, said diaphragm having a first side in contact with the fluid medium and an opposed second side configured to be struck by the striker to generate a supersonic pulse propagated in the liquid fluid medium as the at least one shock wave signal.

5. The system of claim 4, wherein the diaphragm is formed from plastic and comprises a resonator section in a central portion of the diaphragm, said resonator section spanning longitudinally between the first and second sides of the diaphragm, said resonator section configured to be struck by the striker to generate the supersonic pulse.

6. The system of claim 2, wherein the at least one shock wave generator comprises a resonator configured to resonate when excited and emit a supersonic pulse that causes at least one shock wave signal in the liquid fluid medium.

7. The system of claim 6, wherein the resonator is formed from aluminium and comprises a pair of opposed ends and an elongate body extending therebetween, said resonator being of solid construction.

8. The system of claim 7, wherein the at least one shock wave generator further comprises a body for at least partially housing the resonator and an excitation source for exciting the resonator and causing the resonator to resonate.

9. The system of claim 8, wherein the body comprises an upper wall, an opposed lower wall, at least one side wall extending therebetween, and a bore extending through the upper and lower walls and configured to at least partially receive the resonator therethrough such that an upper end of the resonator at least partially protrudes above the upper wall of the body and a lower end of the resonator at least partially protrudes past the lower wall of the body to be in contact with or near the fluid medium.

10. The system of claim 9, wherein the resonator is slidably moveable in the bore and is slidable between a raised position in which the upper end at least partially protrudes outwards from the upper wall of the body and a lowered position.

11. The system of claim 10, wherein when in the lowered position the lower end of the resonator is in contact with the fluid medium.

12. The system of claim 11, wherein the excitation source comprises a striking mechanism for striking an upper end of the resonator to thereby excite the resonator and cause emission of the supersonic pulse.

13. The system of claim 12, wherein the lower end of the resonator comprises at least one concave recess defined thereon, said at least one concave recess comprising curved or angled sidewalls.

14. The system of claim 13, wherein when the resonator is struck by the striking mechanism, the resonator functions as a piston in the bore of the body and slides to the lowered position causing the lower end of the resonator to displace at least a portion of the liquid fluid medium and guide or shape the at least one shock wave signal propagated in the liquid fluid medium away from the shock wave generator.

15. The system of claim 1, wherein the at least one shock wave signal introduced into the liquid fluid medium comprises a shock wave that travels through the liquid fluid medium along the conduit.

16. The system of claim 1, wherein the at least one shock wave signal introduced into the liquid fluid medium creates at least one bubble-pulse at a lower end of a resonator of the at least one shock wave generator, which generates secondary shock wave signals that travel along the conduit in the liquid fluid medium as the at least one bubble-pulse oscillates, said second shock wave signals creating further bubble-pulses along the conduit.

17. The system of claim 1, wherein the at least one detector is configured to detect excitation signals in the liquid fluid medium caused by propagation of the at least one shock wave signal in the liquid fluid medium.

18. The system of claim 1, wherein the at least one processor is further configured to measure a time between introduction of the at least one shock wave signal and detection of the excitation signals to determine a location of the fluid leak along the conduit.

19. A method of detecting a fluid leak in a conduit containing a liquid fluid medium, said method comprising:
introducing at least one shock wave signal into the liquid fluid medium;
sensing one or more parameters of the liquid fluid medium subject to the at least one shock wave signal; and
identifying one or more excitation signals caused by the shock wave signal in the one or more parameters sensed to identify the fluid leak.

20. The method of claim 19, wherein said sensing is undertaken by at least one detector configured to detect and measure said one or more parameters comprising sound waves and pressure waves in the liquid fluid medium.

21. The method of claim 20, wherein said identifying comprises receiving signal data from the at least one detector corresponding to said one or more parameters detected and measured and analysing said signal data and identifying any signals having a characteristic frequency profile of a bubble pulse characterised by a series or peaks of amplitude and duration as a function of time corresponding to the oscillations of the bubble pulse.
